(19) United States
(12) Patent Application Publication
(10) Pub. No.: US 2026/0064987 A1
(43) Pub. Date: Mar. 5, 2026

(54) CHAT CONTROL SYSTEM, CHAT CONTROL METHOD, AND INFORMATION STORAGE MEDIUM

(71) Applicant: Rakuten Group, Inc., Tokyo (JP)

(72) Inventors: Minh The NGUYEN, Tokyo (JP); Tu Tuan TRAN, Tokyo (JP)

(21) Appl. No.: 19/309,510

(22) Filed: Aug. 25, 2025

(30) Foreign Application Priority Data
Aug. 27, 2024 (JP) 2024-145714

(51) Int. Cl. G06F 40/40

(52) U.S. Cl. CPC G06F 40/40

(57) ABSTRACT

Provided is an intermediate agent system which stores shared information generated based on at least one of a chat message received from a user terminal or an answer received from a first LLM in a shared information storage module. The intermediate agent system outputs, to a second LLM, a prompt including an instruction to refer to the shared information storage module based on the chat message received from the user terminal. The intermediate agent system outputs, to the user terminal, a chat message based on an answer from the second LLM in response to the prompt.

### CROSS-REFERENCE TO RELATED APPLICATION

The present application claims priority from Japanese application JP2024-145714 filed on Aug. 27, 2024, the content of which is hereby incorporated by reference into this application.

### BACKGROUND OF THE INVENTION

### 1. Field of the Invention

The present invention relates to a chat control system, a chat control method, and an information storage medium.

### 2. Description of Related Art

In recent years, a technology which makes use of a large language model (LLM) has been attracting attention. As an example of this technology, in Japanese Patent Translation Publication No. 2024-521053, there is described a technology which uses a large language model in generating an automated assistant response.

### SUMMARY OF THE INVENTION

The user repeats output of a prompt to the LLM and reception of an answer from the LLM, to thereby be able to acquire information in an interactive manner. Moreover, in recent years, LLMs having various characteristics have appeared, and it is convenient for the user to be able to acquire various types of information in a unified manner without paying attention to existence of those LLMs.

However, the plurality of LLMs are independent of one another, and hence, when some of pieces of information acquired through communication to and from a terminal and a first LLM are required by a second LLM, it is required to identify the information required by the second LLM out of those pieces of the information, to generate a prompt including the identified information, and to output the generated prompt to the second LLM. Thus, a load for generating the prompt is imposed. In particular, when the amount of information acquired through the communication to and from the terminal and the LLM is enormous, the load for generating the prompt is very high.

The present disclosure addresses the above-mentioned problem, and provides a chat control system, a chat control method, and an information storage medium with which it is possible to reduce a load imposed by generation of a prompt while enabling a user to acquire information from a plurality of LLMs in a unified manner.

(1) A chat control system according to at least one embodiment of the present invention includes: first prompt generation means for generating, based on a chat message received from a terminal, a prompt directed to a first large language model; first prompt output means for outputting the prompt directed to the first large language model to the first large language model; first chat message output means for outputting, to the terminal, a chat message based on an answer from the first large language model in response to the prompt directed to the first large language model; shared information generation means for generating shared information based on at least one of a chat message received from the terminal or the answer received from the first large language model, and storing the generated shared information in shared information storage means; second prompt generation means for generating a prompt that includes an instruction to refer to the shared information storage means and is directed to a second large language model; second prompt output means for outputting the prompt directed to the second large language model to the second large language model; and second chat message output means for outputting, to the terminal, a chat message based on an answer from the second large language model in response to the prompt directed to the second large language model.

(2) In the chat control system according to the above-mentioned item (1), the first prompt output means may output, to each of a plurality of the first large language models, the prompt directed to each of the plurality of the first large language models, the first chat message output means may output, to the terminal, for each of the plurality of the first large language models, a chat message based on an answer from each of the plurality of the first large language models, the shared information generation means may generate a plurality of pieces of shared information and store the generated plurality of pieces of shared information in the shared information storage means, and the second prompt generation means may generate a prompt that includes an instruction to refer to the shared information storage means storing the plurality of pieces of shared information and is directed to the second large language model.

(3) The chat control system according to the above-mentioned item (1) or (2) may further include lacking information generation request reception means for receiving a generation request for lacking information from the second large language model, and the shared information generation means may generate the lacking information when the generation request is received, and store, as shared information, the generated lacking information in the shared information storage means.

(4) The chat control system according to the above-mentioned item (3) may further include third chat message output means for outputting, to the terminal, when the generation request is received, a chat message that requests the lacking information, and the shared information generation means may generate the lacking information based on a chat message received from the terminal in response to the chat message that requests the lacking information.

(5) The chat control system according to the above-mentioned item (3) may further include third prompt output means for outputting, to a large language model different from the second large language model, a prompt for giving an instruction to generate the lacking information when the generation request is received, and the shared information generation means may generate the lacking information based on an answer in response to the prompt for giving an instruction to generate the lacking information from the large language model to which the prompt is output.

(6) In the chat control system according to any one of the above-mentioned items (1) to (5), the second chat message output means may output, to the terminal, a chat message based on the answer from the first large language model in response to the prompt directed to the first large language model and the answer from the second large language model in response to the prompt directed to the second large language model.

(7) A chat control method according to at least one embodiment of the present invention includes the steps of: generating, based on a chat message received from a terminal, a prompt directed to a first large language model; outputting the prompt directed to the first large language model to the first large language model; outputting, to the terminal, a chat message based on an answer from the first large language model in response to the prompt directed to the first large language model; generating shared information based on at least one of a chat message received from the terminal or the answer received from the first large language model, and storing the generated shared information in shared information storage means; generating a prompt that includes an instruction to refer to the shared information storage means and is directed to a second large language model; outputting the prompt directed to the second large language model to the second large language model; and outputting, to the terminal, a chat message based on an answer from the second large language model in response to the prompt directed to the second large language model.

(8) An information storage medium according to at least one embodiment of the present invention is a non-transitory computer readable information storage medium storing a program that causes a computer to execute the steps of: generating, based on a chat message received from a terminal, a prompt directed to a first large language model; outputting the prompt directed to the first large language model to the first large language model; outputting, to the terminal, a chat message based on an answer from the first large language model in response to the prompt directed to the first large language model; generating shared information based on at least one of a chat message received from the terminal or the answer received from the first large language model, and storing the generated shared information in shared information storage means; generating a prompt that includes an instruction to refer to the shared information storage means and is directed to a second large language model;

outputting the prompt directed to the second large language model to the second large language model; and outputting, to the terminal, a chat message based on an answer from the second large language model in response to the prompt directed to the second large language model.

### BRIEF DESCRIPTION OF THE DRAWINGS

FIG. 1 is a diagram for illustrating an example of a configuration of a chat system in at least one embodiment of the present invention.

FIG. 2 is a functional block diagram for illustrating an example of functions of an intermediate agent system in the at least one embodiment of the present invention.

FIG. 3 is a table for showing an example of shared information.

FIG. 4 is a table for showing an example of the shared information.

FIG. 5 is a table for showing an example of the shared information.

FIG. 6A is a flowchart for illustrating an example of a flow of processing executed in the intermediate agent system in the at least one embodiment of the present invention.

FIG. 6B is a flowchart for illustrating the example of the flow of the processing executed in the intermediate agent system in the at least one embodiment of the present invention.

### DESCRIPTION OF THE EMBODIMENTS

Hereinafter, at least one embodiment of the present invention will be described in detail with reference to the drawings.

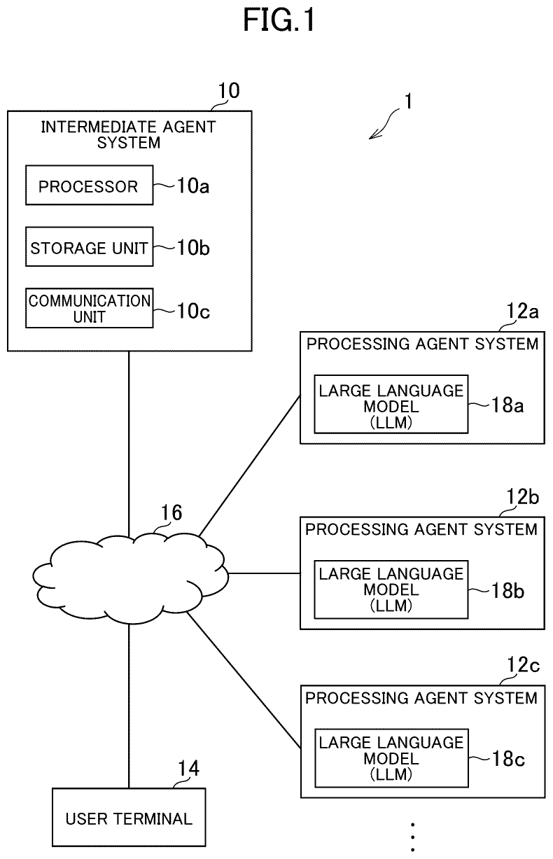

FIG. 1 is a diagram for illustrating an example of a configuration of a chat system 1 in the at least one embodiment of the present invention. As illustrated in FIG. 1, the chat system 1 in the at least one embodiment includes an intermediate agent system 10, a plurality of processing agent systems 12 (12a, 12b, 12c, . . . ), and a user terminal 14. The intermediate agent system 10, the processing agent systems 12, and the user terminal 14 are connected to a computer network 16 such as the Internet. In FIG. 1, three processing agent systems 12 included in the chat system 1 are illustrated as an example, but the number of processing agent systems 12 included in the chat system 1 is not limited to three.

The intermediate agent system 10 may be formed of a computer, for example, a server computer. The intermediate agent system 10 may include a processor 10a such as a CPU, a storage unit 10b such as a memory or a hard disk drive, and a communication unit 10c such as a network interface card. The intermediate agent system 10 may include a plurality of computers or one computer.

The processing agent system 12 may be formed of a server computer including, for example, a CPU, a GPU, a memory, and a communication interface. Moreover, the processing agent system 12 may include a plurality of computers or one computer. In the at least one embodiment, a trained large language model (LLM) 18 is implemented in each of the processing agent systems 12 in the at least one embodiment. As illustrated in FIG. 1, in the at least one embodiment, for example, in the processing agent system 12a, the processing agent system 12b, and the processing agent system 12c, an LLM 18a, an LLM 18b, and an LLM 18c are implemented, respectively. Moreover, the LLM 18a, the LLM 18b, and the LLM 18c are independent of one another.

The user terminal 14 may be formed of a computer (e.g., a personal computer, a smartphone, or a tablet terminal) including, for example, a CPU, a memory, a communication interface, an input device, and a display.

In the at least one embodiment, the roles of the respective processing agent systems 12 are different from one another. For example, in the processing agent system 12a, a purchase history of products by a user who uses the user terminal 14 may be stored. Moreover, for example, in the processing agent system 12b, information on a bank account of the user of the user terminal 14 may be stored. Moreover, for example, in the processing agent system 12c, information indicating credit card usage of the credit card owned by the user of the user terminal 14 may be stored.

Moreover, in the at least one embodiment, communication of a chat message occurs between the intermediate agent system 10 and the user terminal 14. That is, in the at least one embodiment, for the intermediate agent system 10, the user terminal 14 corresponds to a terminal being a communication partner of the chat message.

Further, in the at least one embodiment, the intermediate agent system 10 determines an output destination (here, for example, an output destination of a chat message or a prompt) out of the LLM 18a, the LLM 18b, the LLM 18c, and the user terminal 14 as required based on a chat message received from the user terminal 14. A determination method for the output destination is described later.

Moreover, when the user terminal 14 is determined as the output destination, the intermediate agent system 10 outputs, to the user terminal 14, a chat message serving as a reply to a chat message received from the user terminal 14. Further, when any one of the LLMs 18 is determined as the output destination, the intermediate agent system 10 outputs the prompt to the determined LLM 18. Then, the intermediate agent system 10 generates a chat message based on an answer to the prompt from the LLM 18, and outputs the generated chat message to the user terminal 14.

As described above, the intermediate agent system 10 in the at least one embodiment mediates the communication of the data between the user terminal 14 and each of the plurality of LLMs 18.

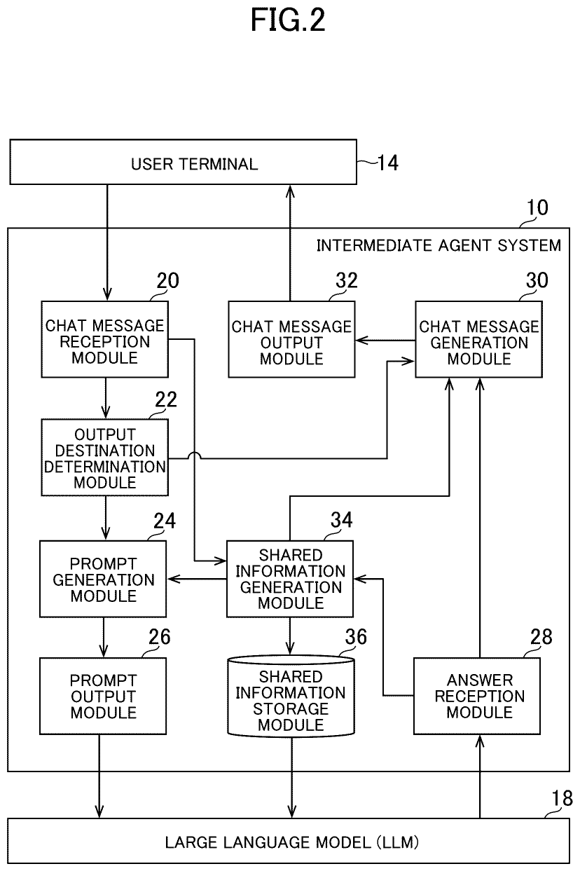

FIG. 2 is a functional block diagram for illustrating an example of functions implemented in the intermediate agent system 10 in the at least one embodiment. In the intermediate agent system 10 in the at least one embodiment, it is not required that all of the functions illustrated in FIG. 2 be implemented, and a function other than the functions illustrated in FIG. 2 may be implemented.

As illustrated in FIG. 2, the intermediate agent system 10 in the at least one embodiment functionally includes, for example, a chat message reception module 20, an output destination determination module 22, a prompt generation module 24, a prompt output module 26, an answer reception module 28, a chat message generation module 30, a chat message output module 32, a shared information generation module 34, and a shared information storage module 36. The intermediate agent system 10 in the at least one embodiment plays a role as a chat control system which controls the chat executed in the chat system 1. The chat message reception module 20, the prompt output module 26, the answer reception module 28, and the chat message output module 32 are implemented mainly by the communication unit 10c. The output destination determination module 22, the prompt generation module 24, the chat message generation module 30, and the shared information generation module 34 are implemented mainly by the processor 10a. The shared information storage module 36 is implemented mainly by the storage unit 10b.

The above-mentioned functions may be implemented by executing, in the intermediate agent system 10, a program installed on the intermediate agent system 10 being the computer, and including instructions corresponding to the above-mentioned functions. Moreover, the program may be supplied to the intermediate agent system 10 via a computer-readable information storage medium, for example, an optical disc, a magnetic disk, a magnetic tape, or a magneto-optical disk, or via the Internet or the like.

In the at least one embodiment, for example, the chat message reception module 20 receives a chat message from the user terminal 14.

In the at least one embodiment, for example, the output destination determination module 22 determines an output destination based on the chat message received by the chat message reception module 20. Here, for example, a publicly-known natural language processing technology such as a topic modeling technology or an estimation technology that uses a trained machine learning model may be used to estimate a topic indicated by the chat message received by the chat message reception module 20. Then, the output destination may be determined based on the estimated topic. For example, when a received message relates to purchase such as “Tell me recommended products,” the LLM 18a may be determined as the output destination. When the received message relates to a bank account of the user such as “Tell me the bank account balance,” the LLM 18b may be determined as the output destination. When the received message relates to a credit card such as “Raise the limit on the credit card,” the LLM 18c may be determined as the output destination. Moreover, when the received message is another chat message, the user terminal 14 may be determined as the output destination.

In the at least one embodiment, for example, when any one of the LLMs 18 is determined as the output destination, the prompt generation module 24 generates a prompt directed to the determined LLM 18. The prompt generation module 24 may generate the prompt directed to the determined LLM 18 based on the chat message received by the chat message reception module 20.

The prompt output module 26 outputs the prompt generated by the prompt generation module 24 to the LLM 18 determined by the output destination determination module 22.

The answer reception module 28 receives an answer to the prompt from the LLM 18 to which the prompt was output by the prompt output module 26.

In the at least one embodiment, for example, the chat message generation module 30 generates a chat message to be output to the user terminal 14.

In the at least one embodiment, for example, the chat message output module 32 outputs the chat message generated by the chat message generation module 30 to the user terminal 14.

When the user terminal 14 is determined as the output destination by the output destination determination module 22, the chat message generation module 30 may generate a predetermined chat message or a chat message determined in accordance with a predetermined logic based on the received chat message. Then, the chat message output module 32 may output the chat message thus generated to the user terminal 14.

Moreover, when the answer reception module 28 receives an answer from the LLM 18, the chat message generation module 30 may generate, in response to the reception of the answer, a chat message based on the answer. Here, a chat message including the answer may be generated. The chat message may be the same character string as the answer, or may be a character string different therefrom. For example, a chat message obtained by processing the answer (for example, obtained by translating the answer) may be generated. Then, the chat message output module 32 may output the chat message based on the answer to the user terminal 14.

In the at least one embodiment, for example, the shared information generation module 34 generates, based on at least one of the chat message received from the user terminal 14 or the answer received from the LLM 18, shared information which all of the plurality of LLMs 18 included in the chat system 1 can refer to, and stores the generated shared information in the shared information storage module 36.

Here, the shared information generation module 34 may identify non-generated shared information out of a plurality of types of shared information defined in advance. Then, the shared information generation module 34 may use, for example, a publicly-known natural language processing technology such as a name identification technology, a topic modeling technology, or an estimation technology that uses the trained machine learning model to determine whether or not each of the pieces of shared information identified yet to have been generated can be generated based on the chat message received from the user terminal 14. As another example, the shared information generation module 34 may use, for example, the above-mentioned natural language processing technology to determine whether or not each of the pieces of shared information identified yet to have been generated can be generated based on the answer received from the LLM 18. Further, the shared information generation module 34 may generate the shared information the generation of which is determined to be possible. Moreover, the shared information generation module 34 may output the generated shared information to the shared information storage module 36.

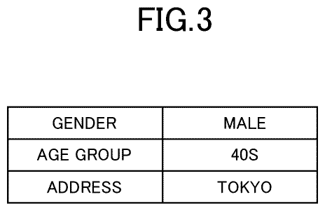

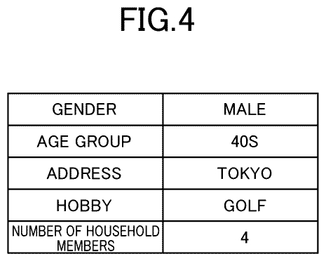

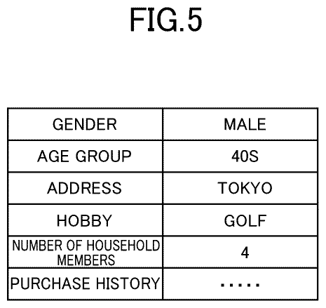

FIG. 3, FIG. 4, and FIG. 5 are tables for showing examples of the shared information. As shown in FIG. 3, FIG. 4, and FIG. 5, each piece of shared information includes a combination of an index and a value. In FIG. 3, three pieces of shared information are shown. In FIG. 4, five pieces of shared information are shown. In FIG. 5, six pieces of shared information are shown.

In the at least one embodiment, for example, no shared information is stored in the shared information storage module 36 in an initial state. In response to the generation of the shared information, the generated shared information is successively accumulated in the shared information storage module 36.

Here, for example, it is assumed that the types (indices) of the shared information of a plurality of types defined in advance are “gender,” “age group,” “address,” “hobby,” and “number of household members.” In this case, it is assumed that the generation of the shared information having “gender” in the index, the shared information having “age group” in the index, and the shared information having “address” in the index is determined to be possible based on the chat message received from the user terminal 14. In this case, as shown in FIG. 3, those three pieces of shared information are generated, and are stored in the shared information storage module 36.

Then, in the at least one embodiment, the prompt generation module 24 may generate a prompt including an instruction to refer to the shared information storage module 36. Further, the prompt output module 26 may output, to the LLM 18, the prompt including the instruction to refer to the shared information storage module 36.

For example, it is assumed that the URL of the shared information storage module 36 is “http://aaa.bbb.ccc.” In this case, a prompt including a character string such as “Please refer to information under http://aaa.bbb.ccc, and answer” may be generated.

Then, the LLM 18 which receives the prompt may refer to the reference destination indicated in the prompt to generate the answer.

Here, the LLM 18 may generate an answer including a generation request for lacking information being information lacking for the generation of the answer. Then, the LLM 18 may output the answer thus generated to the processing agent system 12. Further, the answer reception module 28 of the processing agent system 12 may receive the generation request for the lacking information (here, for example, an answer including the generation request for the lacking information). Moreover, when the answer reception module 28 receives the generation request for the lacking information, the shared information generation module 34 may generate the lacking information, and may store, as the shared information, the generated lacking information in the shared information storage module 36.

Here, when the answer reception module 28 receives the generation request for the lacking information, the shared information generation module 34 may output, to the chat message generation module 30, an instruction to generate a chat message which requests the lacking information. Then, the chat message generation module 30 may generate the chat message which requests the lacking information. Further, the chat message output module 32 may output the chat message thus generated to the user terminal 14. Moreover, the shared information generation module 34 may generate the lacking information based on the chat message received from the user terminal 14 in response to the chat message which requests the lacking information.

For example, it is assumed that the answer reception module 28 receives an answer including a character string “Please tell me your hobby and the number of household members.” In this case, the chat message generation module 30 may generate a chat message including the character string “Please tell me your hobby and the number of household members” and the chat message output module 32 may output the chat message to the user terminal 14. Then, the chat message reception module 20 may receive a chat message output from the user terminal 14 in response to the chat message. Further, the shared information generation module 34 may determine, based on the chat message received by the chat message reception module 20, whether or not it is possible to generate the shared information having “hobby” in the index and the shared information having “number of household members” in the index. Moreover, when the generation of those pieces of shared information is possible, the shared information generation module 34 may generate those pieces of shared information, and may store the generated shared information in the shared information storage module 36. In this case, as shown in FIG. 4, those two pieces of shared information are generated, and are then stored in the shared information storage module 36.

Then, the prompt generation module 24 may generate a prompt including a character string such as “The hobby and the number of household members have been registered as information under http://aaa.bbb.ccc.” Further, the prompt output module 26 may output the prompt to the LLM 18 which has output the answer including the character string “Please tell me your hobby and the number of household members.”

Moreover, for example, when the answer reception module 28 receives the generation request for the lacking information, the shared information generation module 34 may output, to the prompt generation module 24, an instruction to generate a prompt for giving an instruction to generate the lacking information. Then, the prompt generation module 24 may generate the prompt for giving an instruction to generate the lacking information. Further, the prompt output module 26 may output the prompt to the LLM 18 different from the LLM 18 which has output the generation request for the lacking information. Then, the shared information generation module 34 may generate the lacking information based on an answer in response to the prompt from the LLM 18 to which the prompt for giving an instruction to generate the lacking information is output.

For example, it is assumed that the answer reception module 28 receives an answer including a character string “Please tell me your product purchase history” from the LLM 18c. In this case, the prompt generation module 24 may generate a prompt including a character string “Please tell me your product purchase history” and the prompt output module 26 may output the prompt to the LLM 18a. Then, the answer reception module 28 may receive an answer output from the LLM 18a in response to the prompt. Further, the shared information generation module 34 may generate shared information having “purchase history” in the index based on the answer received by the answer reception module 28, and may store the generated shared information in the shared information storage module 36. In this case, as shown in FIG. 5, the shared information is generated, and is then stored in the shared information storage module 36.

Then, the prompt generation module 24 may generate a prompt including a character string such as “Product purchase history has been registered as information under http://aaa.bbb.ccc.” Further, the prompt output module 26 may output the prompt to the LLM 18c.

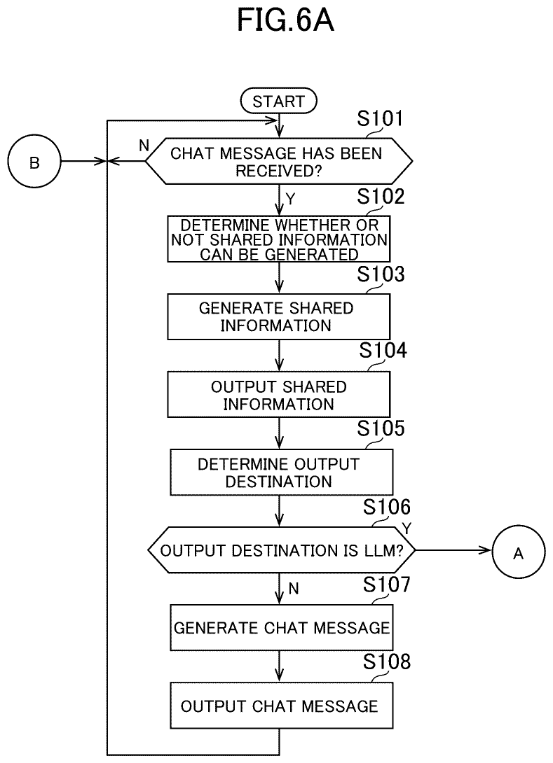

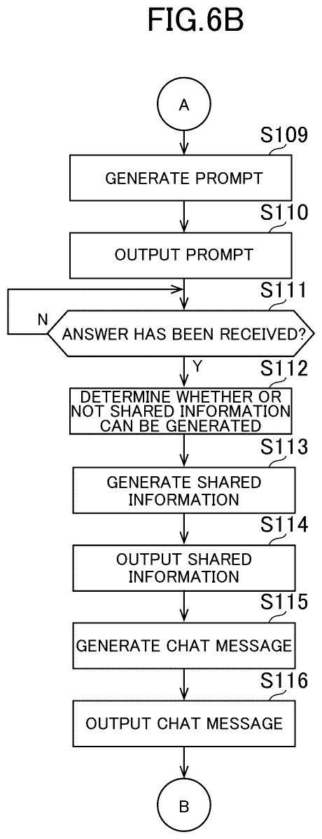

Here, with reference to a flowchart exemplified in FIG. 6A and FIG. 6B, description is given of an example of a flow of processing executed in the intermediate agent system 10 in the at least one embodiment. In this processing example, it is assumed that types (indices) of the shared information to be generated are defined in advance.

In this processing example, the chat message reception module 20 waits for the reception of the chat message (Step S101).

When the reception of the chat message is detected in the processing step of Step S101, the shared information generation module 34 determines whether or not each of the pieces of non-generated shared information can be generated based on the chat message the reception of which is detected in the processing step of Step S101 (Step S102).

Then, the shared information generation module 34 generates, based on the chat message the reception of which is detected in the processing step of Step S101, the shared information the generation of which is determined to be possible in the processing step of Step S102 (Step S103), and outputs the generated shared information to the shared information storage module 36 (Step S104). When there is no shared information the generation of which is determined to be possible in the processing step of Step S102, the processing steps of Step S103 and Step S104 are not executed.

Then, the output destination determination module 22 determines the output destination based on the chat message the reception of which is detected in the processing step of Step S101 (Step S105). After that, the output destination determination module 22 checks whether or not the output destination determined in the processing step of Step S105 is any one of the LLMs 18 (Step S106).

When the determined output destination is not the LLM 18 (but is the user terminal 14) (N in Step S106), the chat message generation module 30 generates a chat message (Step S107). The chat message output module 32 then outputs, to the user terminal 14, the chat message generated in the processing step of Step S107 (Step S108), and the process returns to the processing step of Step S101.

When the determined output destination is the LLM 18 (Y in Step S106), the prompt generation module 24 generates a prompt that includes the instruction to refer to the shared information storage module 36 and is directed to the LLM 18 (Step S109), and the prompt output module 26 outputs the generated prompt to the LLM 18 (Step S110). In the processing step of Step S109, a prompt that includes, for example, the instruction to refer to the shared information storage module 36 and the character string indicated by the chat message the reception of which is detected in the processing step of Step S101 may be generated.

Then, the answer reception module 28 waits for the answer to the prompt from the LLM 18 (Step S111).

When the reception of the answer is detected in the processing step of Step S111, the shared information generation module 34 determines whether or not each of the pieces of non-generated shared information can be generated based on the answer the reception of which is detected in the processing step of Step S111 (Step S112).

Then, the shared information generation module 34 generates, based on the answer the reception of which is detected in the processing step of Step S111, the shared information the generation of which is determined to be possible in the processing step of Step S112 (Step S113), and outputs the generated shared information to the shared information storage module 36 (Step S114). When there is no shared information the generation of which is determined to be possible in the processing step of Step S112, the processing steps of Step S113 and Step S114 are not executed.

Then, the chat message generation module 30 generates a chat message based on the answer the reception of which is detected in the processing step of Step S111 (Step S115), and the chat message output module 32 outputs the chat message generated in the processing step of Step S115 to the user terminal 14 (Step S116). After that, the process returns to the processing step of Step S101.

In the at least one embodiment, for example, the prompt generation module 24 may generate a prompt directed to the first LLM 18 (for example, the LLM 18a) based on the chat message received from the user terminal 14. Here, for example, a prompt including the character string indicated by the chat message received from the user terminal 14 may be generated. As another example, a prompt including the instruction to refer to the shared information storage module 36 and the character string indicated by the chat message received from the user terminal 14 may be generated. After that, the prompt output module 26 may output the prompt to the first LLM 18.

Then, the chat message output module 32 may output, to the user terminal 14, a chat message based on an answer, from the first LLM 18 (for example, the LLM 18a), in response to the prompt directed to the first LLM 18 (for example, the LLM 18a). Here, for example, a chat message including a character string indicating the answer from the LLM 18a may be output to the user terminal 14.

Here, the shared information generation module 34 may generate the shared information based on at least one of the chat message received from the user terminal 14 or the answer received from the first LLM 18 (for example, the LLM 18a), and store the generated shared information in the shared information storage module 36.

Then, the prompt generation module 24 may generate a prompt directed to a second LLM 18 (for example, the LLM 18c) and including the instruction to refer to the shared information storage module 36. Here, for example, a prompt including the instruction to refer to the shared information storage module 36 and the character string indicated by the chat message received from the user terminal 14 may be generated.

For example, it is assumed that the prompt generation module 24 generates, based on a certain chat message received from the user terminal 14, a prompt directed to the first LLM 18 (for example, the LLM 18a). In this case, the prompt generation module 24 may generate, based on the chat message, a prompt that includes the instruction to refer to the shared information storage module 36 and is directed to the second LLM 18 (for example, the LLM 18c). As another example, the prompt generation module 24 may generate, based on a chat message different from the first chat message, a prompt that includes the instruction to refer to the shared information storage module 36 and is directed to the second LLM 18 (for example, the LLM 18c). After that, the prompt output module 26 may output the prompt to the second LLM 18 (for example, the LLM 18c).

Then, the chat message output module 32 may output, to the user terminal 14, a chat message based on an answer, from the second LLM 18 (for example, the LLM 18c), in response to the prompt directed to the second LLM 18 (for example, the LLM 18c). Here, for example, a chat message including a character string indicating the answer from the LLM 18c may be output to the user terminal 14.

In the description given above, a plurality of the above-mentioned first LLMs 18 may exist. For example, the LLM 18a and the LLM 18b may correspond to the above-mentioned first LLMs 18.

Moreover, the prompt output module 26 may output, to each of the plurality of the first LLMs 18, the prompt directed to the first LLM 18. For example, the prompt output module 26 may output, to the LLM 18a, the prompt based on a first chat message received from the user terminal 14, and may output, to the LLM 18b, the prompt based on a second chat message received from the user terminal 14.

Then, the chat message output module 32 may output, to the user terminal 14, for each of the plurality of first LLMs 18, a chat message based on the answer from the first LLM 18. For example, the chat message output module 32 may output, to the user terminal 14, a chat message based on the answer in response to the first chat message from the LLM 18a. Moreover, the chat message output module 32 may output, to the user terminal 14, a chat message based on the answer in response to the second chat message from the LLM 18b.

Then, the shared information generation module 34 may generate a plurality of pieces of shared information and store the generated plurality of pieces of shared information in the shared information storage module 36. For example, the shared information generation module 34 may generate the shared information based on at least one of the first chat message or the answer received from the LLM 18a, and store the generated shared information in the shared information storage module 36. After that, the shared information generation module 34 may generate the shared information based on at least one of the second chat message or the answer received from the LLM 18b, and store the generated shared information in the shared information storage module 36.

Then, the prompt generation module 24 may generate a prompt that includes the instruction to refer to the shared information storage module 36 which stores the plurality of pieces of shared information and is directed to the second LLM 18 (for example, the LLM 18c). After that, the prompt output module 26 may output the prompt to the second LLM 18 (for example, the LLM 18c).

Moreover, in the at least one embodiment, the chat message output module 32 may output, to the user terminal 14, a chat message based on the answer from the first LLM 18 (for example, the LLM 18a) in response to the prompt directed to the first LLM 18 (for example, the LLM 18a) and the answer from the second LLM 18 (for example, the LLM 18c) in response to the prompt directed to the second LLM 18 (for example, the LLM 18c).

For example, the prompt generation module 24 may generate a prompt directed to the LLM 18a and a prompt directed to the LLM 18c in response to the reception of the chat message from the user terminal 14 by the chat message reception module 20. In this case, the prompt directed to the LLM 18a and the prompt directed to the LLM 18c may be the same. For example, prompts including the instruction to refer to the shared information storage module 36 and a character string indicated by the chat message may be generated as the prompt directed to the LLM 18a and the prompt directed to the LLM 18c. The prompt directed to the LLM 18a and the prompt directed to the LLM 18c may be different from each other.

Then, the prompt output module 26 may output, to the LLM 18a, the prompt directed to the LLM 18a, and output, to the LLM 18c, the prompt directed to the LLM 18c. After that, the answer reception module 28 may receive an answer from the LLM 18a and an answer from the LLM 18c. Further, the chat message generation module 30 may generate a chat message based on those answers (for example, a chat message including a character string indicating the answer from the LLM 18a and a character string indicating the answer from the LLM 18c). After that, the chat message output module 32 may output the chat message to the user terminal 14.

Moreover, in the at least one embodiment, the shared information generation module 34 may generate log information including the chat message received by the chat message reception module 20, and store the log information in the shared information storage module 36 as the shared information. Further, the shared information generation module 34 may generate log information including the answer received by the answer reception module 28, and store the log information in the shared information storage module 36 as the shared information. Moreover, the shared information generation module 34 may generate log information including the chat message generated by the chat message generation module 30, and store the log information in the shared information storage module 36 as the shared information.

Then, the prompt output module 26 may output, to the LLM 18, a prompt including the instruction to refer to the shared information storage module 36 which stores the log information.

In the at least one embodiment, the user of the user terminal 14 communicates the chat messages to and from the processing agent system 12, to thereby be able to acquire, without paying attention to existence of the plurality of LLMs 18, various types of information from those LLMs 18 in a unified manner.

Moreover, in the at least one embodiment, the shared information is generated based on at least one of the chat message received from the user terminal 14 or the answer received from the first LLM 18, and the generated shared information is stored in the shared information storage module 36. Then, the prompt that includes the instruction to refer to the shared information storage module 36 and is directed to the second LLM 18 is output to the second LLM 18 based on the chat message received from the user terminal 14. After that, the second LLM 18 selects the shared information required in order to generate the answer from the information stored in the shared information storage module 36, and can generate the answer based on the selected shared information.

Thus, in the at least one embodiment, even when the second LLM 18 requires some of the pieces of information acquired through the communication to and from the user terminal 14 and the first LLM 18, it is not required to identify information required by the second LLM 18 out of the pieces of the information, to generate a prompt including the identified information, and to output the generated prompt to the second LLM 18.

As described above, according to the at least one embodiment, it is possible to reduce a load imposed by generation of a prompt while enabling the user to acquire information from the plurality of LLMs 18 in a unified manner.

The present invention is not limited to the above-mentioned at least one embodiment. For example, the shared information storage module 36 may be provided to not the intermediate agent system 10, but a system different from the intermediate agent system 10.

The above-mentioned specific character strings and numerical values and specific character strings and numerical values of the drawings are only exemplary, and the present invention is not limited to those character strings and numerical values.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A chat control system, comprising:
at least one processor; and
at least one memory device storing instructions which, when executed by the at least one processor, cause the at least one processor to perform operations comprising:
generating, based on a chat message received from a terminal, a prompt directed to a first large language model;
outputting the prompt directed to the first large language model to the first large language model;
outputting, to the terminal, a chat message based on an answer from the first large language model in response to the prompt directed to the first large language model;
generating shared information based on at least one of a chat message received from the terminal or the answer received from the first large language model, and storing the generated shared information in a shared information storage module;
generating a prompt that includes an instruction to refer to the shared information storage module and is directed to a second large language model;
outputting the prompt directed to the second large language model to the second large language model; and
outputting, to the terminal, a chat message based on an answer from the second large language model in response to the prompt directed to the second large language model.

2. The chat control system according to claim 1,
wherein the outputting the prompt directed to the first large language model to the first large language model includes:
outputting, to each of a plurality of the first large language models, the prompt directed to each of the plurality of the first large language models,
wherein the outputting, to the terminal, the chat message based on the answer from the first large language model in response to the prompt directed to the first large language model includes outputting, to the terminal, for each of the plurality of the first large language models, a chat message based on an answer from each of the plurality of the first large language models,
wherein the generating the shared information and storing the generated shared information in the shared information storage module includes generating a plurality of pieces of shared information and storing the generated plurality of pieces of shared information in the shared information storage module, and
wherein the generating the prompt that includes the instruction to refer to the shared information storage module and is directed to the second large language model includes generating a prompt that includes an instruction to refer to the shared information storage module storing the plurality of pieces of shared information and is directed to the second large language model.

3. The chat control system according to claim 1,
wherein the operations further comprise:
receiving a generation request for lacking information from the second large language model, and
wherein the generating the shared information and storing the generated shared information in the shared information storage module includes generating the lacking information when the generation request is received, and storing, as shared information, the generated lacking information in the shared information storage module.

4. The chat control system according to claim 3,
wherein the operations further comprise:
outputting, to the terminal, when the generation request is received, a chat message that requests the lacking information, and
wherein the generating the shared information and storing the generated shared information in the shared information storage module includes generating the lacking information based on a chat message received from the terminal in response to the chat message that requests the lacking information.

5. The chat control system according to claim 3,
wherein the operations further comprise:
outputting, to a large language model different from the second large language model, a prompt for giving an instruction to generate the lacking information when the generation request is received, and
wherein the generating the shared information and storing the generated shared information in the shared information storage module includes generating the lacking information based on an answer in response to the prompt for giving an instruction to generate the lacking information from the large language model to which the prompt is output.

6. The chat control system according to claim 1, wherein the outputting, to the terminal, the chat message based on the answer from the second large language model in response to the prompt directed to the second large language model includes:
outputting, to the terminal, a chat message based on the answer from the first large language model in response to the prompt directed to the first large language model and the answer from the second large language model in response to the prompt directed to the second large language model.

7. A chat control method, comprising:
generating, based on a chat message received from a terminal, a prompt directed to a first large language model;
outputting the prompt directed to the first large language model to the first large language model;
outputting, to the terminal, a chat message based on an answer from the first large language model in response to the prompt directed to the first large language model;
generating shared information based on at least one of a chat message received from the terminal or the answer received from the first large language model, and storing the generated shared information in a shared information storage module;
generating a prompt that includes an instruction to refer to the shared information storage module and is directed to a second large language model;
outputting the prompt directed to the second large language model to the second large language model; and
outputting, to the terminal, a chat message based on an answer from the second large language model in response to the prompt directed to the second large language model.

8. A non-transitory computer readable information storage medium storing a program that causes a computer to execute:
generating, based on a chat message received from a terminal, a prompt directed to a first large language model;
outputting the prompt directed to the first large language model to the first large language model;
outputting, to the terminal, a chat message based on an answer from the first large language model in response to the prompt directed to the first large language model;
generating shared information based on at least one of a chat message received from the terminal or the answer received from the first large language model, and storing the generated shared information in a shared information storage module;
generating a prompt that includes an instruction to refer to the shared information storage module and is directed to a second large language model;
outputting the prompt directed to the second large language model to the second large language model; and
outputting, to the terminal, a chat message based on an answer from the second large language model in response to the prompt directed to the second large language model.
